(19) United States
(12) Patent Application Publication
(10) Pub. No.: US 2025/0205026 A1
(43) Pub. Date: Jun. 26, 2025

(54) HANDHELD ORAL CARE DEVICE

(71) Applicant: Stim Mie Inc., Toronto (CA)

(72) Inventor: Stephanie Nightingale, Toronto (CA)

(21) Appl. No.: 18/804,232

(22) Filed: Aug. 14, 2024

Related U.S. Application Data
(60) Provisional application No. 63/612,542, filed on Dec. 20, 2023.

(51) Int. Cl. A61C 15/02

(52) U.S. Cl. CPC A61C 15/02

(57) ABSTRACT

A handheld oral care device includes a shank having a shank longitudinal axis extending from a shank distal end to a shank proximal end. The shank has at least three sides extending between the shank distal end and the shank proximal end. Each of the sides includes at least one longitudinally extending groove. Each groove can extend at least one third of the length of the side. The device further includes a head having a head longitudinal axis extending from a head proximal end with a pointed oral stimulation tip to a head distal end. The head longitudinal axis is at least 20 degrees from parallel to the shank longitudinal axis. The device further includes a neck connecting the shank proximal end to the head distal end.

### CROSS-REFERENCE TO RELATED APPLICATIONS

This application claims the benefit of U.S. Provisional Patent Application No. 63/612,542, entitled “HANDHELD ORAL CARE DEVICE” and filed Dec. 20, 2023, which is incorporated by reference in its entirety for all purposes.

### FIELD

The application relates to the field of dental hygiene, and more specifically to the field of handheld oral care devices.

### INTRODUCTION

Maintaining good oral hygiene holds considerable importance for many. This includes clean, plaque-free teeth and healthy gums. It is also desirable to maintain oral hygiene at all times, especially when away from home. Many current oral care devices are large and bulky, making them difficult to travel. Other more portable devices are disposable and therefore hard on the environment.

Consequently, there is a need for a portable and reusable oral care device that effectively cleans and removes plaque from teeth and maintains gum health.

### SUMMARY

The following summary is intended to introduce the reader to various aspects of the applicant's teaching, but not to define any invention.

According to some aspects, a handheld oral care device includes a shank having a shank longitudinal axis extending from a shank distal end to a shank proximal end. The shank has at least three sides extending between the shank distal end and the shank proximal end. Each of the sides includes at least one longitudinally extending groove. Each groove can extend at least one third the length of the side. The apparatus further includes a head having a head longitudinal axis extending from a head proximal end with a pointed oral stimulation tip to a head distal end. The head longitudinal axis is at least 20 degrees from parallel to the shank longitudinal axis. The apparatus further includes a neck connecting the shank proximal end to the head distal end.

### BRIEF DESCRIPTION OF THE DRAWINGS

For a better understanding of the described examples and to show more clearly how they may be carried into effect, reference will now be made, by way of example, to the accompanying drawings in which:

FIG. 1 is a perspective view of an example oral care device;

FIG. 2A is a left-side view of the oral care device of FIG. 1;

FIG. 2B is a right-side view of the oral care device of FIG. 1;

FIG. 3A is a top view of the oral care device of FIG. 1;

FIG. 3B is a bottom view of the oral care device of FIG. 1;

FIG. 4A is an enlarged perspective view of a head of the oral care device of FIG. 1 in an installed position; and

FIG. 4B is an enlarged perspective view of the head of the oral care device of FIG. 1 in a removed position.

FIG. 5A is a perspective view of another example oral care device with an example cap;

FIG. 5B is a perspective view of the cap of FIG. 5A;

FIG. 5C is a cross-sectional enlarged view of a head of the oral care device of FIG. 5A;

FIG. 5D is another perspective view of the cap of FIG. 5A;

FIG. 6A is a perspective view of an oral care device in a first holding position;

FIG. 6B is a perspective view of the oral care device of FIG. 6A in a second holding position;

FIG. 6C is a perspective view of the oral care device of FIG. 6A in a third holding position; and

FIG. 6D is perspective view of the oral care device of FIG. 6A in a fourth holding position.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

Some elements herein may be identified by a part number, which is composed of a base number followed by an alphabetical or subscript-numerical suffix (e.g. 112a, or 112₁). Multiple elements herein may be identified by part numbers that share a base number in common and that differ by their suffixes (e.g. 112₁, 112₂, and 112₃). All elements with a common base number may be referred to collectively or generically using the base number without a suffix (e.g. 112).

Many people are away from the home for extended periods of time each day, undertaking various activities that can include eating and drinking. Although oral care is typically performed at home, it is desirable to maintain oral hygiene at all times, irrespective of whether people are at home or away from home. When away from the home, facilities may not be available to clean an oral care device prior/after use. As well, a mirror may not be readily available to help guide a user as the oral care device is used. Even if a mirror is available, it may be handheld and leave only one hand for holding the oral care device.

Some oral care devices, such as gum massagers, can be undesirable to travel with for various reasons including their size, weight, and general inconvenience. For example, an oral care device that is large may not fit in a bag, may be at greater risk of being damaged or broken, or simply be embarrassing to use publicly.

Oral care devices also need to be clean for use. It is desirable for oral care devices to be kept clean so they can be readily used without first cleaning the device as cleaning facilities may not be available. Some oral care devices are disposable so that it is unnecessary to keep them clean between uses. However, disposable devices can be undesirable from an environmental perspective.

According to some aspects of the present disclosure, the oral care device can be compact and small, which allows it to be easier to travel with, have a lower risk of being damaged or broken, and be used discretely or inconspicuously. An oral care device that is ergonomic can be intuitively easier to use, particularly when a mirror is not available or when used single-handedly.

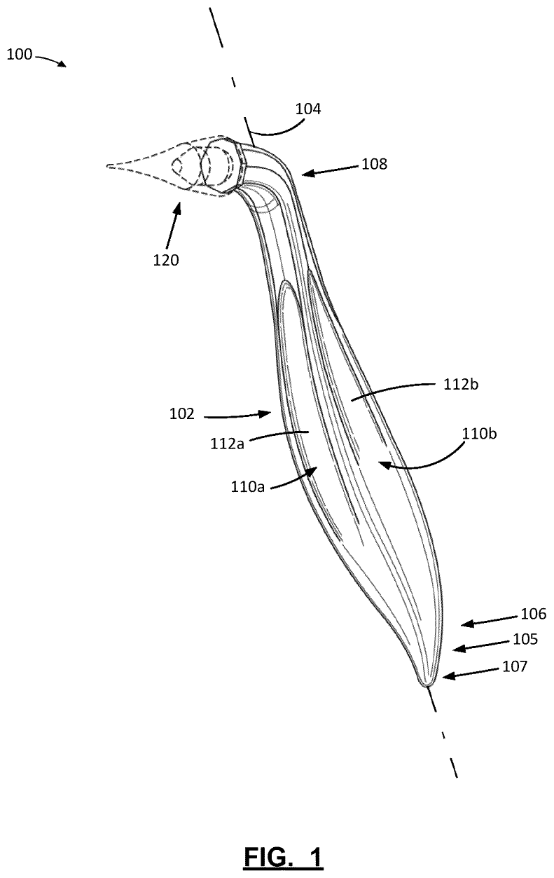

Reference is now made to FIG. 1 which shows an example oral care device 100. The device 100 is a handheld tool. The device 100 has a shank 102 and a head 120.

The shank 102 has a shank longitudinal axis 104. The shank longitudinal axis 104 extends from a shank distal end 106 to a shank proximal end 108. The shank 102 has at least three sides 110 extending between the shank distal end 106 and the shank proximal end 108. The at least three sides 110 can include left, right and top sides 110. The device 100 can optionally include a bottom side 110. The example device 100 shown has four sides 110a (also referred to as bottom side 110a), 110b (also referred to as right side 110b), 110c (also referred to as top side 110c), and 110d (also referred to as left side 110d). Other embodiments can have more than four sides 110. The top side 110c extends laterally from the left side 110d to the right side 110b. The bottom side 110a extends laterally from the left side 110d to the right side 110b. The sides 110 are located at least in a proximal portion of the shank 102 (i.e., towards the proximal end 108).

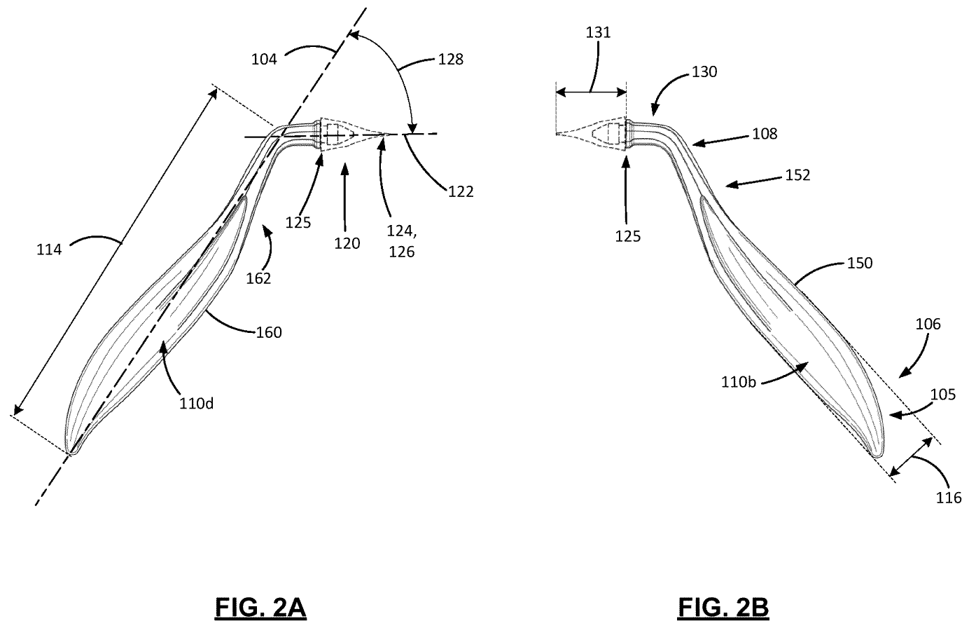

Referring to FIG. 2A, a length 114 of each the sides 110 in the longitudinal direction is on the centimeter (cm) scale. The length 114 of the sides 110 can provide a compact form for the device 100. For example, the device 100 can have a length 114 suitable for fitting within a user's hand and/or pocket. For example, the length 114 can measure about 7 cm. In other examples, the length 114 can be greater than 7 cm but less than about 10 cm, for providing a user with greater control and dexterity of the device 100 or for reaching further into the mouth of a user. In other examples, the length 114 can be less than 7 cm but greater than about 5 cm, for providing a shorter shank 102 for children, for example, or for increasing the portability of the device.

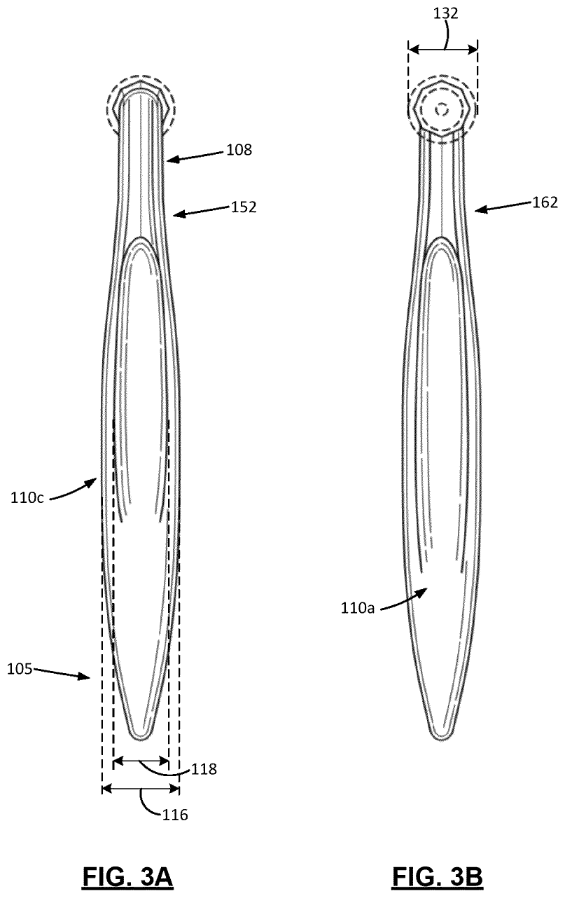

Referring to FIG. 2B, a maximum side width 116 of each the sides 110 is on the millimeter (mm) scale. The maximum side width 116 of one side 110 can be different from the maximum side width 116 of another side 110 for better ergonomics and dexterity. For example, the maximum side width 116 of the right and left sides 110b, 110d can measure about 12 mm. In other examples, the maximum side width of the right and left sides 110b, 110d can be greater than 12 mm but less than about 15 mm, to allow for better grip of the shank 102. In other examples, the maximum side width 116 of the right and left sides 110b, 110d can be less than 12 mm but greater than about 6 mm for providing a smaller and more portable device. Referring to FIG. 3A, the maximum side width 116 of the bottom and top sides 110a, 110c can measure about 7 mm. In other examples, the maximum side width of the bottom and top sides 110a, 110c can be greater than 7 mm but less than about 15 mm, to provide a thicker shank 102 for better control of the device 100. In other examples, the maximum side width 116 of the bottom and top sides 110a, 110c can be less than 7 mm but greater than about 6 mm for providing a flatter shank 102 with enhanced stability. Device 100 is shown for illustrative purposes only. The position of the maximum side width 116 of each the sides 110 along the shank longitudinal axis 104 can vary.

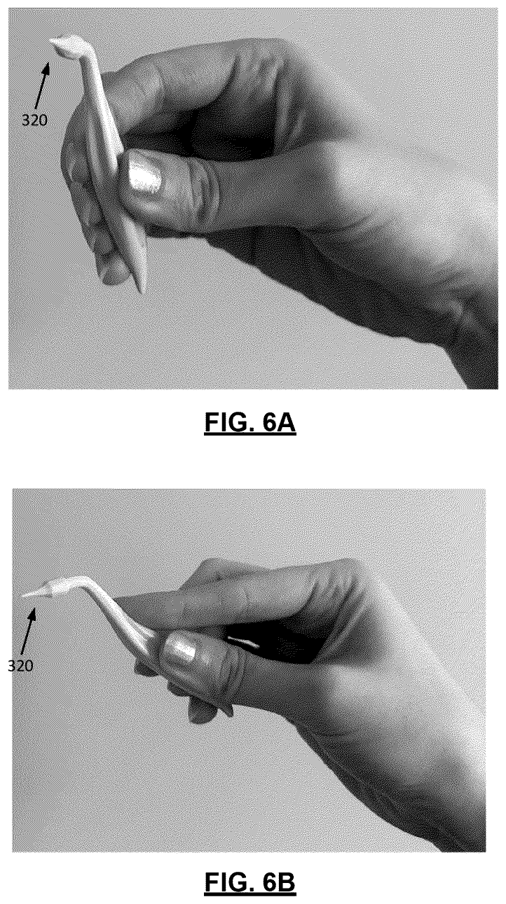

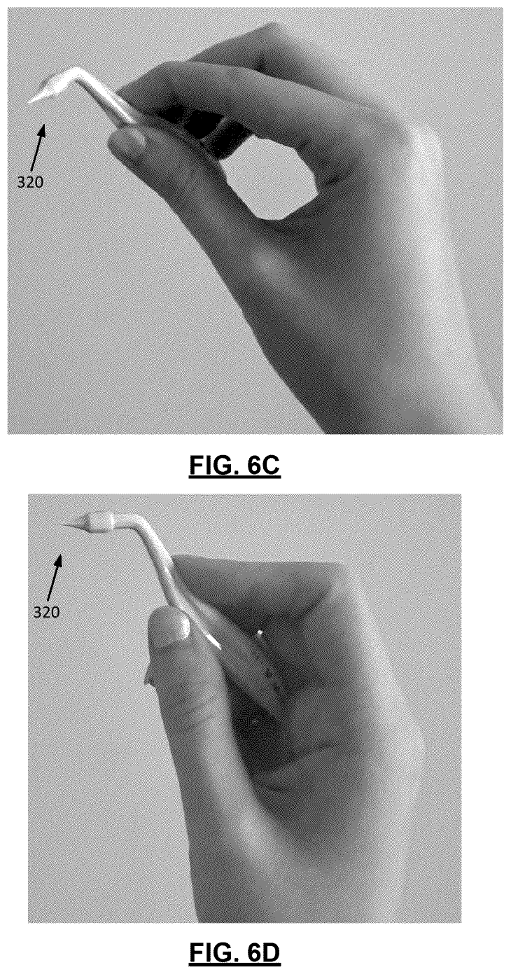

Referring back to FIG. 1, each of the sides 110 has at least one longitudinally extending groove 112. In the illustrated example, each of the sides 110a, 110b, 110c, 110d has one respective groove 112a, 112b, 112c, 112d. Other embodiments of the device 100 can have more than one groove 112 per side 110. The grooves 112 allow for better grip of the shank 102 by the user and provide a surface for the user's fingers to engage with the shank 102. A user can hold the device 100 by engaging with two or more of the grooves 112. For example, a user can hold the device 100 by engaging with the right and left side grooves 112b, 112d (see, e.g., FIG. 6A). A user can also hold the device 100 by engaging with the right side, left side and top grooves 112b, 112c, 112d (see, e.g., FIG. 6B). A user can also hold the device 100 by engaging with the bottom and top grooves 112a, 112c (see, e.g., FIG. 6C). Other holding positions are possible. One or more fingers of the user can engage with each groove 112 depending on the holding position. Therefore, the grooves 112 do not only provide texture to the sides 110, but enable better gripping of the shank 102 by the user. The orientation of the device 300 in FIG. 6A and FIG. 6C with the head 320 downwards is shown for illustrative purposes only. A user can also hold the device 300 by engaging with the right and left side grooves 112b, 112d or by engaging with the bottom and top grooves 112a, 112c with the head 320 upwards.

Each groove 112 can extend at least one third of the length of the respective side 110. For example, as shown in FIG. 1, the grooves 112a and 112b extend about one half of the length of the sides 110a and 110b, respectively. Each groove 112 has at least a portion of the groove 112 that is concave and has a groove depth into the shank 102. In some embodiments, the groove depth can be about 1 millimeter (mm). In some embodiments, the groove depth can be greater than 1 mm but less than 5 mm.

In some examples, the groove depth of at least one groove 112 varies longitudinally. In some examples, the groove depth of each groove 112 varies longitudinally. For example, as can be seen in FIG. 1, the right side groove 112b is concave towards the proximal end 108. The concavity of the groove 112b tapers off towards the distal end 106 (i.e., the groove depth of the groove 112b decreases towards the distal end 106), where the groove ends and the side 110b is generally flat.

Each groove 112 has a groove width. In some examples, the groove width of at least one groove 112 varies longitudinally. In some examples, the groove width of each groove 112 varies longitudinally. For example, as can be seen in FIGS. 2A and 2B, the groove width of right side groove 112b and left side groove 112b can decrease towards the shank proximal end 108. Each groove 112 can have a maximum groove width 118. As shown in FIG. 3A, the maximum groove width 118 is less than the maximum side width 116. Device 100 is shown for illustrative purposes only. The position of the maximum groove width 118 along the shank longitudinal axis 104 can vary.

In some examples, the shank 102 can form a shank tip 107 at the shank distal end 106. The shank tip 107 may be useful for removing dental and orthodontic appliances, such as but not limited to, retainers, aligners, or other dental trays.

The shank 102 can be formed of a semi-rigid material. For example, the semi-rigid material can be, but is not limited to a polymeric material or rubber. The semi-rigid material can allow the shank 102 to be lightweight, easy to hold, and withstand pressure from travel. Polymeric material that is moisture resistant and water repelling can also offer greater durability.

Referring back to FIG. 2A, the device 100 includes a head 120. The head 120 has a head longitudinal axis 122. The head longitudinal axis 122 extends from a head proximal end 124 with a pointed oral stimulation tip 126 to a head distal end 125. The pointed oral stimulation tip 126 can glide between teeth to remove food. The pointed oral stimulation tip 126 can be used to sweep under the gums to remove food and plaque. The device 100 has a singular oral stimulation tip 126—that is, the pointed tip 126 is formed of a unitary body. A unitary body can be more durable compared to, for example, multiple small parts such as bristles.

The head longitudinal axis 122 can intersect at an angle 128 with the shank longitudinal axis 104. That is, the head longitudinal axis 122 is non-parallel to the shank longitudinal axis 104. The head longitudinal axis 122 is at least 20 degrees from parallel to the shank longitudinal axis 104. In other words, the angle 128 is at least 20 degrees. In the example shown in FIG. 2A, the angle 128 is about 55 degrees. An angle 128 of between 20 and about 55 degrees allows for the user to comfortably hold the device 100 and for the tip 126 to properly clean the teeth and gums. In other examples, the angle 128 can be greater than 55 degrees but less than about 90 degrees in order to provide a device 100 that can better access hard-to-reach places within a user's mouth.

Referring to FIG. 2B, the head 120 has a head maximum length 131 on the millimeter (mm) scale. In the example shown, the head maximum length 131 is about 15 mm. In other examples, the head maximum length can be as little as about 10 mm but less than about 20 mm. A head maximum length 131 between about 10 to 20 mm provides for a head size that is optimal for reaching between and cleaning teeth. In some examples, the head maximum length 131 is about five times less than the length 114 of each the sides 110.

Referring to FIG. 3B, the head distal end 125 is generally circular and has a head maximum width 132 on the millimeter (mm) scale. In the example shown, the head maximum width 132 is about 6 mm. In other examples, the head maximum width can be as little as about 4 mm but less than about 8 mm. A head maximum width 132 between about 4 to 8 mm provides a head 120 that is slim enough to fit between teeth and around gums, but not so slim to allow for a user to cause damage to the gums. A relatively larger head maximum width 132 prevents the head 120 of the device 100 from being inserted too far into the gums and causing tissue trauma (e.g., punched out papilla).

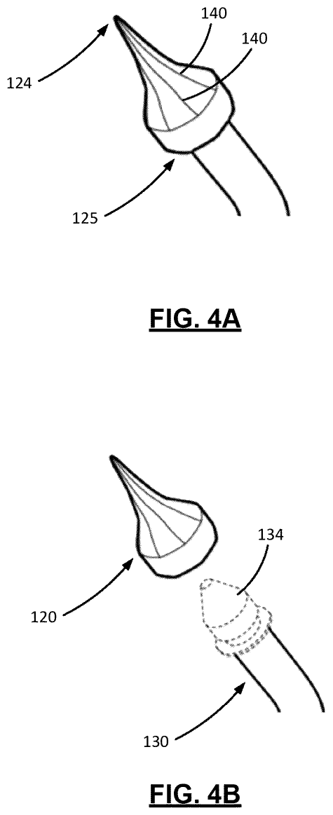

Referring to FIG. 4A, the head 120 includes at least two ridges 140 extending between the head proximal end 124 and the head distal end 125. The head 120 can include eight or more ridges 140. The ridges 140 can provide improved stimulation of gums and access to crevices. The head 120 can be formed of a semi-rigid material, similar to the shank. For example, the semi-rigid material can be, but is not limited to a polymeric material or rubber. The semi-rigid material allows for the oral stimulation tip 126 to withstand pressure, but be safe and comfortable for a user when removing debris such as food and plaque from between teeth and under gums. The semi-rigid material can also allow a user to comfortably press and massage against the gums using the head distal end 125. Polymeric material that is moisture resistant and water repelling can also offer greater durability.

Referring to FIG. 2B, the device 100 includes a neck 130. The neck 130 connects the shank proximal end 108 to the head distal end 128. As shown in FIG. 4B, the neck 130 can include a connection portion 134. The connection portion 134 can be fixed to the neck 130. The connection portion 134 can receive the head 120.

In some embodiments, such as that shown in FIG. 4B, the head 120 can be removably attached to the connection portion 134. The connection portion 134 can allow for the head 120 to be removed and replaced after many uses, extending the life of the device 100. The replaceable head 120 can reduce the need to replace the entire device 100. In some embodiments, the head 120 can be fixed to the connection portion. That is, the head 120 may not be removable and replaceable. The fixed head 120 can avoid inadvertent detachment and reduces the risk that the head 120 is lost during travel.

Referring back to FIG. 2B, the top side 110c has a side profile 150 that is convex at least in a distal portion of the shank 102 (i.e., towards the shank distal end 106). The convex shape of the side profile 150 of the top side 110c can provide a hand brace surface 105 (see, e.g., FIG. 1). The hand brace surface 105 can allow for the shank distal end 106 to rest comfortably against the palm of a user (see, e.g., FIG. 6D). In particular, the hand brace surface 105 can allow the shank distal end 106 to rest comfortably against the palm of a user when the user engages with the top and bottom grooves 112a, 112c. The hand brace surface 105 can optionally abut a portion of a user's hand, such as the palm or finger. In some examples, the hand brace surface 105 can nest in a curved portion of a user's hand, such as a curved finger or palm (see, e.g., FIG. 6D). The position of the hand brace surface 105 provides the user with a more secure grip of the device 100, additional control of the movement of the device 100, and control of the application of force when using the device 100.

The side profile 150 is concave at least in a proximal portion of the shank 102 (i.e., towards the shank proximal end 108). This concavity in the side profile 150 provides another surface 152 with which the user can engage the device 100. The groove 112c can be located along the portion of side 110c that has the concave side profile 150, further enhancing the ergonomics and dexterity of the device 100. The concave side profile 150 provides a curved surface 152 for a user's finger (e.g., index finger) to comfortably rest and control the device 100 (see, e.g., FIG. 6D). The side profile 150 of the top side 110c having both a convex shape in the distal portion of the shank 102 and a concave shape in the proximal portion of the shank 102 can provide an “S” curve.

Referring back to FIG. 2A, the bottom side 110a has a side profile 160 that is sloped at least in a proximal portion of the shank 102 (i.e., towards the shank proximal end 108). This slope in the side profile 160 provides another surface 162 with which the user can engage the device 100. The groove 112a can be located along the portion of side 110a that has the sloped side profile 160, further enhancing the ergonomics and dexterity of the device 100. The sloped side profile 160 provides a surface 162 for a user's finger (e.g., index finger) to comfortably rest and control the device 100.

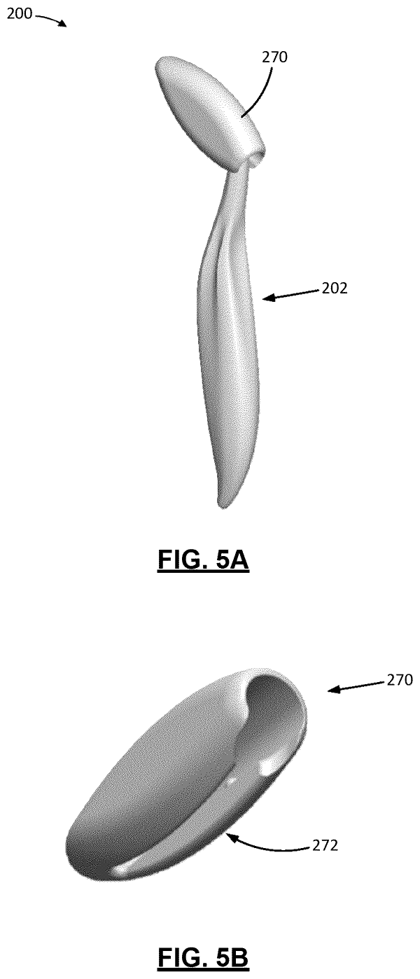

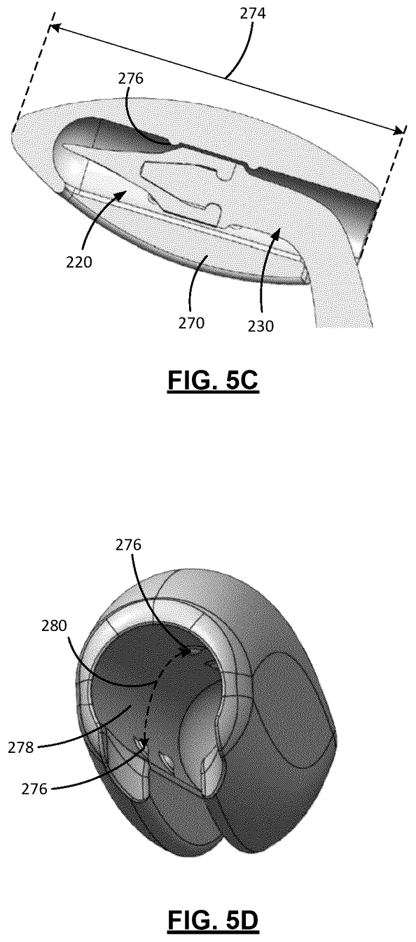

Referring to FIG. 5A to FIG. 5D, shown therein is another example oral care device 200. Similar to device 100, device 200 has a shank 202 and a head 220. The oral care device 200 can optionally further include a cap 270. The cap 270 is removably mountable to the neck 230 for enclosing the head 220. The cap 270 includes at least one slit 272. The slit 272 allows for ventilation to the head 220 to prevent or reduce bacteria growth. The slit 272 extends along at least half a length 274 of the cap 270 to provide sufficient ventilation to the head 220. In the example shown, the slit 272 extends about three-quarters of the length 274 to provide a greater amount of ventilation to the head 220 while still sufficiently enclosing the head 220. In other examples, the slit 272 can extend the entire length 274 to provide an even greater amount of ventilation to the head 220. In some embodiments, the cap can include other openings, such as holes, for ventilation.

The cap 270 includes at least two protrusions 276 extending from an interior surface 278 of the cap 270. The protrusions 276 abut one or more of the shank 202 or the head 220 when the cap 270 is mounted to the neck 230. The protrusions 276 help the cap 270 firmly mount to the neck 230 and prevent the accidental removal of the cap 270 from the head 220. At least two protrusions 276 are needed to allow the cap 270 to grip the shank 202 or head 220. In the example shown, the cap 270 has six protrusions 176 to provide a greater amount of grip. As shown in FIGS. 5C and 5D, the protrusions 276 can be positioned in pairs and the pairs can be positioned radially around the head 220, at an angle 280 of approximately 220 degrees apart. In other examples, four protrusions 276 can be provided to grip the shank 202 or head 220. For example, the pair of protrusions 276 engaging a top portion of the head may be omitted. In other examples, up to 22 or more protrusions 276 can be used to increase the amount of grip, while still allowing for the cap 270 to be easily removed from the neck 230 by the user. In some embodiments, the protrusions 276 may not be positioned in pairs. The protrusions 276 shown in FIG. 5D are shown for illustrative purposes. Other configurations are possible. For example, the protrusions 276 can have an elongated shape instead of circular.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1. A handheld oral care device comprising:
a shank having a shank longitudinal axis extending from a shank distal end to a shank proximal end, the shank having at least three sides extending between the shank distal end and the shank proximal end,
each of the sides comprising at least one longitudinally extending groove, each groove extending at least one third the length of the side;
a head having a head longitudinal axis extending from a head proximal end with a pointed oral stimulation tip to a head distal end, the head longitudinal axis being at least 20 degrees from parallel to the shank longitudinal axis; and
a neck connecting the shank proximal end to the head distal end.
   Item 2. The device of any preceding item, wherein:
the at least three sides include left, right, and top sides, the top side extending laterally from the left side to the right side, and
the left, right, and top sides being located at least in a proximal portion of the shank.
   Item 3. The device of any preceding item, wherein:
the at least three sides further includes a bottom side, the bottom side extending laterally from the left side to the right side, and
the bottom side being located at least in the proximal portion of the shank.
   Item 4. The device of any preceding item, wherein the top side has a side profile that is convex at least in a distal portion of the shank.
   Item 5. The device of any preceding item, wherein the top side has a side profile that is concave at least in a proximal portion of the shank.
   Item 6. The device of any preceding item, wherein each groove has a groove depth that varies longitudinally.
   Item 7. The device of any preceding item, wherein the groove depth decreases towards the shank distal end.
   Item 8. The device of any preceding item, wherein each groove has a groove width that varies longitudinally.
   Item 9. The device of any preceding item, wherein the groove width decreases towards the shank proximal end.
   Item 10. The device of any preceding item, wherein the head has a singular pointed oral stimulation tip.
   Item 11. The device of any preceding item, wherein the head comprises at least two ridges extending between the head proximal end and the head distal end.
   Item 12. The device of any preceding item, wherein the head is formed of a semi-rigid material.
   Item 13. The device of any preceding item, wherein the semi-rigid material comprises a polymeric material.
   Item 14. The device of any preceding item, further comprising a cap removably mountable to the neck for enclosing the head.
   Item 15. The device of any preceding item, wherein the cap comprises at least one slit extending along at half a length of the cap.
   Item 16. The device of any preceding item, wherein the cap comprises at least two protrusions extending from an interior surface of the cap, the protrusions abutting one or more of the shank or the head when the cap is mounted to the neck.

1. A handheld oral care device comprising:
a shank having a shank longitudinal axis extending from a shank distal end to a shank proximal end, the shank having at least three sides extending between the shank distal end and the shank proximal end,
each of the sides comprising at least one longitudinally extending groove, each groove extending at least one third the length of the side;
a head having a head longitudinal axis extending from a head proximal end with a pointed oral stimulation tip to a head distal end, the head longitudinal axis being at least 20 degrees from parallel to the shank longitudinal axis; and
a neck connecting the shank proximal end to the head distal end.

2. The device of claim 1, wherein:
the at least three sides include left, right, and top sides, the top side extending laterally from the left side to the right side, and
the left, right, and top sides being located at least in a proximal portion of the shank.

3. The device of claim 2, wherein:
the at least three sides further includes a bottom side, the bottom side extending laterally from the left side to the right side, and
the bottom side being located at least in the proximal portion of the shank.

4. The device of claim 2, wherein the top side has a side profile that is convex at least in a distal portion of the shank.

5. The device of claim 2, wherein the top side has a side profile that is concave at least in a proximal portion of the shank.

6. The device of claim 1, wherein at least one groove has a groove depth that varies longitudinally.

7. The device of claim 6, wherein the groove depth decreases towards the shank distal end.

8. The device of claim 1, wherein at least one groove has a groove width that varies longitudinally.

9. The device of claim 8, wherein the groove width decreases towards the shank proximal end.

10. The device of claim 1, wherein the head has a singular pointed oral stimulation tip.

11. The device of claim 1, wherein the head comprises at least two ridges extending between the head proximal end and the head distal end.

12. The device of claim 1, wherein the head is formed of a semi-rigid material.

13. The device of claim 12, wherein the semi-rigid material comprises a polymeric material.

14. The device of claim 1, further comprising a cap removably mountable to the neck for enclosing the head.

15. The device of claim 14, wherein the cap comprises at least one slit extending along at least half a length of the cap.

16. The device of claim 14, wherein the cap comprises at least two protrusions extending from an interior surface of the cap, the protrusions abutting one or more of the shank or the head when the cap is mounted to the neck.

17. A handheld oral care device comprising:
a shank having a shank longitudinal axis extending from a shank distal end to a shank proximal end, the shank having at least three sides extending between the shank distal end and the shank proximal end,
each of the sides comprising at least one longitudinally extending groove, each
groove having a groove depth that varies longitudinally;
a head having a head longitudinal axis extending from a head proximal end with a pointed oral stimulation tip to a head distal end, the head longitudinal axis being at least 20 degrees from parallel to the shank longitudinal axis; and
a neck connecting the shank proximal end to the head distal end.

18. (canceled)

19. A handheld oral care device comprising:
a shank having a shank longitudinal axis extending from a shank distal end to a shank proximal end, the shank having at least three sides extending between the shank distal end and the shank proximal end,
each of the sides comprising at least one longitudinally extending groove, each
groove having a groove width that varies longitudinally;
a head having a head longitudinal axis extending from a head proximal end with a pointed oral stimulation tip to a head distal end, the head longitudinal axis being at least 20 degrees from parallel to the shank longitudinal axis; and
a neck connecting the shank proximal end to the head distal end.

20. (canceled)

21. The device of claim 17, wherein the groove depth decreases towards the shank distal end.

22. The device of claim 19, wherein the groove width decreases towards the shank proximal end.
